(19) United States
(12) Patent Application Publication
(10) Pub. No.: US 2023/0231858 A1
(43) Pub. Date: Jul. 20, 2023

(54) Cross Company Integration System and Method of Use

(71) Applicant: Ozan Ucar, London (GB)

(72) Inventor: Ozan Ucar, London (GB)

(21) Appl. No.: 18/097,210

(22) Filed: Jan. 14, 2023

Related U.S. Application Data
(60) Provisional application No. 63/299,754, filed on Jan. 14, 2022.

(51) Int. Cl. H04L 9/40

(52) U.S. Cl. CPC H04L 63/1416; H04L 63/20; H04L 63/145

(57) ABSTRACT

A cross company integration system that enables a group of individual or organizations to combine their respective information security assets to protect each of thse individuals or organizations. A real time thread module receives traffic from each of the participants and directs any threats to the solutions that it has access to. The solutions eliminate or otherwise control the threat to protect the affected participant.

### BACKGROUND

The invention relates generally to digital security systems and more specifically to a cross company integration system that provides protection to the information technology assets of multiple groups through the combined power of the security tools and exposure of the groups when united in function as a whole.

Common digital security systems monitor traffic within a computer network to identify, remove, sequester, and prevent malicious activity within the network. Commonly threats enter a computer network through email messages that carry computer code or links to spurious internet sites that extract personal information or seek to create a break in the security of the computer network. The malicious attacks frequently change tactics so that common prevention methods must constantly be improved and updated.

One of the problems associated with common digital security systems is their limited efficiency. For example, to properly protect a computer network many sophisticated security programs are required to monitor the traffic along with a team of experienced professionals. Many companies or individuals do not have access to these programs or a full team of professionals, so their computer networks remain susceptible to malicious threats.

Further, the security programs are constructed to detect and contain specific types of threats and so while the companies or individuals may have access to a single security program it will not protect against all threats.

While developments have been made in the area of common digital security systems room exits for further improvement and in the information technology sector.

### DESCRIPTION OF THE DRAWINGS

The figures include like indicators that represent the same part or feature from one figure to another. The intent of the figures is to illustrate the concepts of the invention and not to limit or restrict the scope of the disclosure.

FIG. 1 is a diagram of a cross company integration system in accordance with the preferred embodiment of the invention;

FIG. 2 is a diagram of the real-time threat module of FIG. 1;

FIG. 3 is a flowchart of a method of evaluating malicious content.

### DESCRIPTION OF THE IDEA

The present invention is described herein to provide insight and knowledge of the idea and the benefits it provides. Aspects of the idea will provide additional benefit to those skilled in the art and should be respected as intellectual property of the inventor. While changes and modifications to the described idea are natural in the development process it is anticipated that these changes will not alter or diminish the scope of the invention.

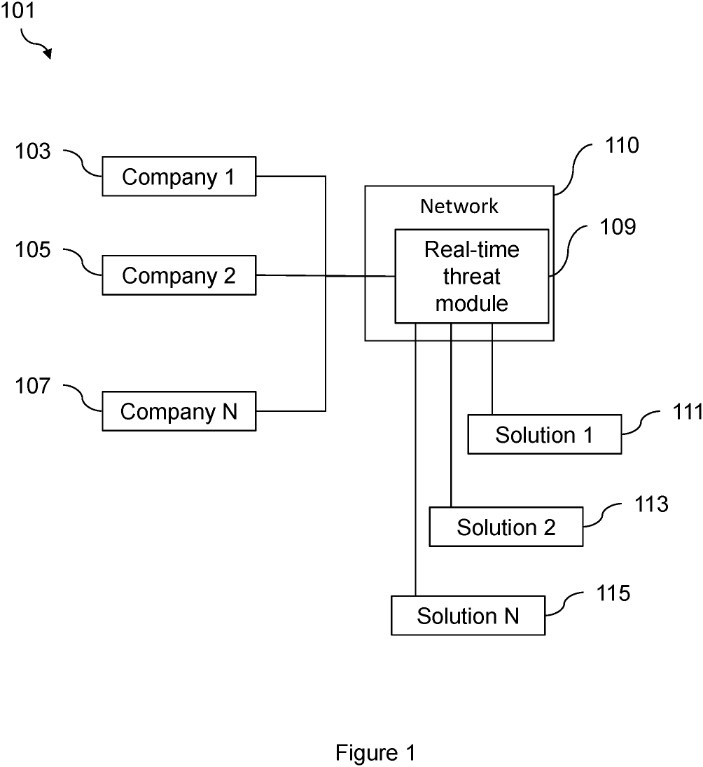

Referring now to the figures of the application the idea will be described in its detail components. It will be understood that like numbers in the various figures are indicative of the same part or piece in multiple figures. FIG. 1 depicts a diagram of a cross company integration system in its preferred embodiment. It will be understood that system 101 provides improvements over common digital security systems.

The preferred embodiment of the system 101 includes entities such a first company 103, a second company 105, and additional companies 107 all in electronic communication with a real-time threat module 109 via a network (110). It is contemplated that any number of companies could be connected in this way. Further, any of the entities could be an organization of any size, an individual, or a group of individuals that share a common computer network. The real-time threat module 109 is also in electronic communication with a first solution 111, a second solution 113, and additional solutions 115. It is contemplated that these solutions could be owned and operated by one of the entities or by the real-time thread module. The solutions could be at any tier of access, such as light and full, they could be duplicates, or any other format.

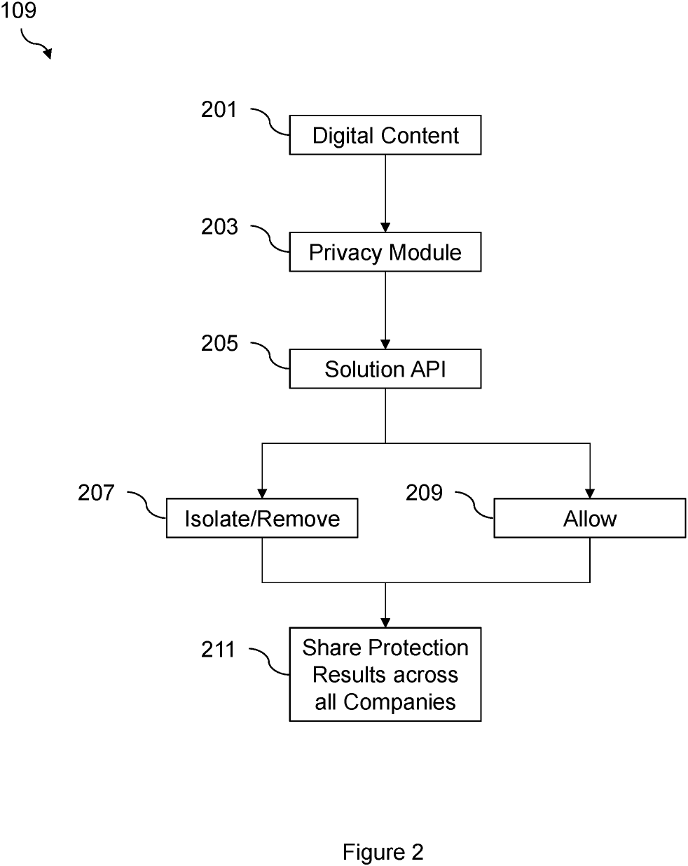

Referring now to FIG. 2 the real-time threat module 109 is depicted and includes a privacy module 203 that receives digital content 201 from the companies and removes any information that the company with the data does not want to release (e.g. contact information). The real-time threat module 109 further includes a solution application programming interface (API) 205 that coordinates the solutions to evaluate the digital content 201 received. The solution API 205 could isolate or remove 207 the content if it is determined to be malicious or allow 209 the content if it is determined to be non-malicious. The real-time threat module 109 then shares protection results with all the companies 211 it is communication with.

In use, a first company 103 with a first solution 111 allows communication with a real-time threat module 109 so that digital content 201 therefrom along with API access to its first solution is active with the real-time threat module 109. A second company 105 with a second solution 113 and an Nth solution 115, in this example the Nth is a third solution, establishes the same communication as the first company 103 with the real-time threat module 109. Additional companies with additional solutions create similar connections. An email arrives at a recipient within the computer network of the first company 103 and is marked as a potential threat either by a user or the real-time threat module 109, the digital content 201 related to this email is filtered through the privacy module 203 and then evaluated by the first solution 111, second solution 113, and Nth solutions 115 to determine the maliciousness thereof. If the email is determined to be malicious it is removed 207 and the results are shared with all of the companies in communication with the real-time threat module 109. The solution that identifies the maliciousness could be from the first company 103, second company 105, or one of the additional companies.

One unique feature of the invention is that any organization can unite with other organizations to leverage the protective capabilities of the group to protect its computer network and electronic communication.

Additionally, the cost to access sophisticated solutions is reduced by the number of organizations that participate with the real-time threat module 109.

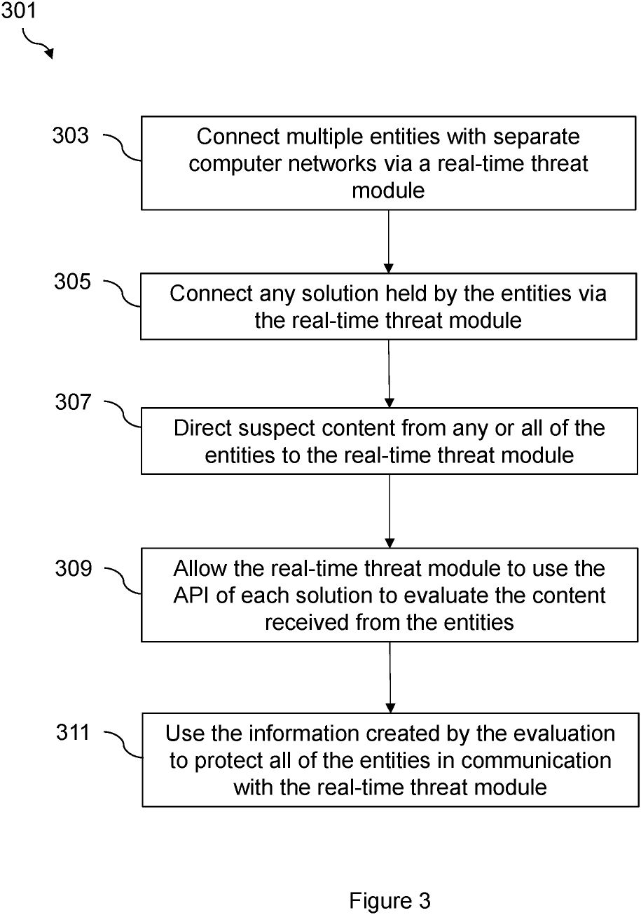

Referring now to FIG. 3, a method of evaluating malicious content is depicted. Method 301 includes connecting multiple entities with separate computer networks via a real-time threat module 303, connecting any solution held by the entities via the real-time threat module 305, directing suspect content from any or all of the entities to the real-time threat module 307, allowing the real-time threat module to use the API of each solution to evaluate the content received from the entities 309, and using the information created by the evaluation to protect all of the entities in communication with the real-time threat module 311.

The concepts and principles described above are not meant to limit the scope of the invention or its manner of implementation. The concepts and principles of the idea are intended to be protected in part and in whole.

What is claimed:

1. A cross company integration system, comprising;
a plurality of entities in electronic communication with a real time threat module;
a plurality of solutions that are each contributed by at least one of the plurality of entities that are operated by the real time thread module;
a privacy module that receives content from the plurality of entities via a network;
wherein the solutions are provided content so that the plurality of solutions work to eliminate digital threats to at least one of the plurality of entities; and
wherein each of the plurality of entities receives increased protection when malicious data is removed from the content.

2. A method of evaluating malicious content, comprising:
connecting multiple entities with separate computer networks via a real-time threat module;
connecting any solution held by the entities via the real-time threat module;
directing suspect content from any or all of the entities to the real-time threat module;
allowing the real-time threat module to use the API of each solution to evaluate the content received from the entities; and
using the information created by the evaluation to protect all of the entities in communication with the real-time threat module.
